(19) United States
(12) Patent Application Publication
(10) Pub. No.: US 2009/0063034 A1
(43) Pub. Date: Mar. 5, 2009

(54) Navigation apparatus using image map and method thereof

(76) Inventor: Xiang Jun Han, Kuei San Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,928

(22) Filed: Aug. 20, 2008

(30) Foreign Application Priority Data
Aug. 30, 2007 (TW) 096132341

(51) Int. Cl. G01C 21/36

(52) U.S. Cl. 701/201; 701/209

(57) ABSTRACT

A navigation apparatus using image map and a method thereof are disclosed. The navigation apparatus comprises a storage module, an input module, a satellite positioning module and a processing module. The storage module is for storing an image map. The input module is for setting a plurality of positioning locations, a plurality of color data, a start location and a target location on the image map. The satellite positioning module is for providing the position data corresponding to these positioning locations. The processing module recognizes several workable routes based on these color data, and then calculates a navigation route from the start location to the target location based on a route planing algorithm, these position data and these workable routes.

### BACKGROUND OF THE INVENTION

1. Field of the Invention

The present invention relates to navigation apparatus, and more particularly to a navigation apparatus capable of using image map other than an electronic map to provide navigation function.

2. Description of the Related Art

At present, almost all global positioning system (GPS) navigation apparatuses carry out a positioning or navigation by an electronic map, such as a vector map, and the important key of the electronic map is road network data.

In general, a conventional method of recognizing and finding road network data of an electronic map usually draws a road map by a vector plotter during a process of generating a vector based geography information system (GIS), and manually inputs complicated road information into a calculator one by one to achieve the purpose of vectorizing a map. However, such method of generating vector map cannot reach the purpose of quickly and easily obtaining the vector map with desired precision. This method also requires a user to manually draw the map based on a paper map first, and then scan the drawing by a scanner, and finally fine tune and vectorize the drawing. In the drawing process, a transparent sheet having the same size of the paper map is placed on top of the paper map, and the track of a road is drawed along the central line of the road by pencil to obtain a black and white road network map, and the road network map is scaned by a scanner to obtain a black and white image map which is then stored in a calculator, and finally, fine tuned and vectorized.

The aforementioned method is a typical method of recognizing geographic information manually. Although the operation is simple and easily, the performing speed of the method is slow and the precision of the electronic map mainly depends on the precision of the paper map and staff's attitude on responsibility. If a more accurate electronic map can be obtained and such method is performed in the condition of a stronger responsibility of the involved staff, a more accurate electronic map can be obtained. However, as the user requirement of the geographic information becomes increasingly higher and the high-performance the calculator develops rapidly, the geographic information processing becomes faster and faster. The manual recognition is a relatively time-consuming and effort-consuming task, and thus the preparation of the geographic information becomes a bottle neck for the development of the geography information system (GIS).

In addition, the road network data can also be obtained by using an image analysis method (or an image recognition method) automatically or semi-automatically. However, there is no image analysis software capable of generating the expected result without assuming relative ideal conditions.

Thereofore, no matter which method is used for obtaining the electronic map, the task is time-consuming and effort-consuming, and that is why the manufacturing cost of the present electronic map is high, and occupies most cost of navigation apparatuses. Since the manufacturing process is complicated, the prior arts still have drawbacks. For example, if a certain place or district cannot be found in the electronic map, navigation for such place or district cannot be provided by the navigation apparatus, or if there is a change on a road but the information of the electronic map is not updated immediately, it causes errors and serious consequences to the navigation.

To overcome the drawbacks of the prior art and satisfy the user requirement of the navigation apparatus and navigation method, the inventor of the present invention based on years of experience in the related field to conduct extensive researches and experiments, and finally developed a navigation apparatus using image map and its method in accordance with the present invention.

### SUMMARY OF THE INVENTION

Therefore, one of objectives of the present invention is to provide a navigation apparatus using image map and its method, for meeting user requirements and overcome the drawbacks of the prior art, in addition the effects of lowering the manufacturing cost and providing a convenient way of automatically updating route information.

To achieve the foregoing objective, the present invention provides a navigation apparatus using image map, and the navigation apparatus comprises a storage module, an input module, a satellite positioning module and a processing module. The storage module is provided for storing an image map. The input module is provided for setting a plurality of positioning locations, a plurality of color data, a start location and a target location on the image map. The satellite positioning module is operable to provide a plurality of position data corresponding to the positioning locations respectively. The processing module is operable to recognize a plurality of workable routes according to the color data and calculate a navigation route from a start location to a target location according to a route planing algorithm, the position data and the workable routes.

Besides, the present invention further provides a navigation method using image map, and the method comprises the following steps:

(a) Provide a navigation apparatus comprising a storage module, an input module, a satellite positioning module and a processing module.

(b) Use the storage module to store an image map.

(c) Use the input module to set a plurality of positioning locations and a plurality of color data on the image map.

(d) Set a start location and a target location on the image map.

(e) Provide a plurality of position data corresponding to the positioning locations respectively by the satellite positioning module.

(f) Recognize a plurality of workable routes according to the color data by the processing module.

(g) Calculate a navigation route from a start location to a target location according to a route planing algorithm, the position data and the workable routes.

### BRIEF DESCRIPTION OF THE DRAWINGS

The subject matter regarded as the invention is particularly pointed out and distinctly claimed in the concluding portion of the specification. The invention, both as to apparatus and method of operation, together with features and advantages thereof may best be understood by reference to the following detailed description with the accompanying drawings in which:

FIG. 1 is a schematic view of a navigation apparatus using image map in accordance with the present invention;

FIG. 2 is a schematic view of a navigation apparatus using image map in accordance with a embodiment of the present invention; and

FIG. 3 is a flow chart of a navigation method using image map in accordance with the present invention.

### DETAILED DESCRIPTION OF THE PREFERRED EMBODIMENTS

The objectives, characteristics and advantages of the present invention will become apparent from the following detailed description taken with the accompanying drawing, and same numerals are used for representing the same elements respectively in the description and drawings of the invention.

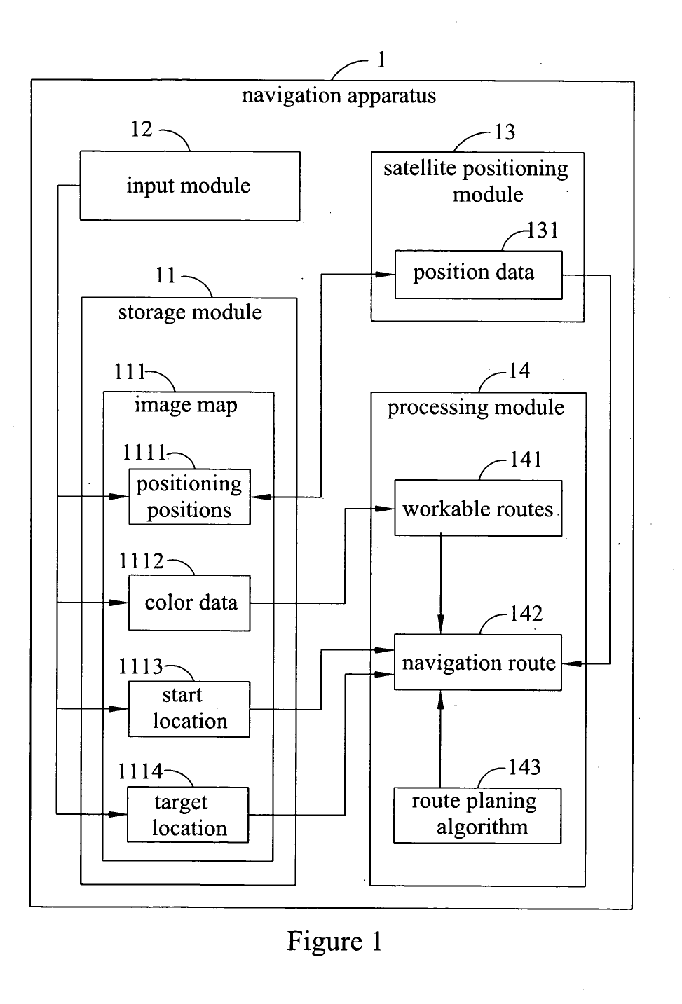

Referring to FIG. 1 for a schematic view of a navigation apparatus using image map in accordance with the present invention, the navigation apparatus 1 comprises a storage module 11, an input module 12, a satellite positioning module 13 and a processing module 14. Preferably, the navigation apparatus 1 can be a global positioning system (GPS) device, a mobile phone with a navigation function or a digital personal assistant with a navigation function. The storage module 11 is provided for storing an image map 111. The input module 12 is provided for setting at least three noncolinear positioning positions 1111, a plurality of color data 1112, a start location 1113 and a target location 1114 on the image map 111, or further setting at least one waypoint position between the start location 1113 and the target location 1114. The input module 12 may alternatively be provided as for example, a touch screen or a press key set.

The satellite positioning module 13 receives GPS data from GPS satellites and calculates its present location based on the GPS data. While being taken to the positioning locations 1111, navigation apparatus 1 can provide a plurality of position data 131 corresponding to the positioning locations 1111 respectively. Preferably, the position data 131 includes latitude and longitude coordinate. The processing module 14 is operable to recognize a plurality of workable routes 141 according to the color data 1112 and calculates a navigation route 142 from a start location 1113 to a target location 1114 according to a route planing algorithm 143, the position data 131 and the workable routes 141. The technique of route planing algorithm is well-known, and for the sake of brevity, further discussion is omitted.

Preferably, the navigation route 142 further includes a non-traveled route and a traveled route, and the non-traveled route is marked by a first color data, and the traveled route is marked by a second color data. Users can define the second color data as a non-workable route, so that the navigation apparatus 1 will not repeatedly use the traveled route to plan route to prevent users from walking through the same workable route 141 again.

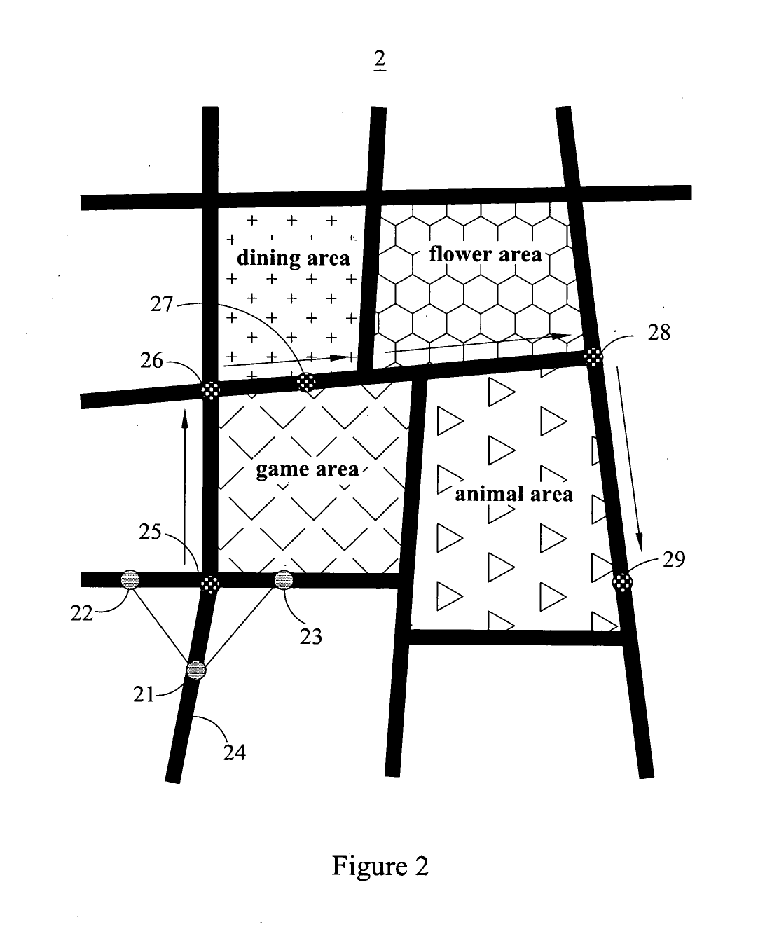

Referring to FIG. 2 for a schematic view of a navigation apparatus using image map in accordance with an embodiment of the present invention, a user obtains a tourist map of a recreation center 2, and the tourist map includes a plurality of recreation areas, such as a dining area, a flower area, a game area and an animal area, and a plurality of paths marked by different colors.

From the beginning, a user can operate an image capturing module of a navigation apparatus (or an electronic device) to take a picture of the tourist map as the image map, and store the image map in a storage module. Preferably, the image capturing module can be a built-in device in the navigation apparatus or an external electronic device connected with the navigation apparatus. The user further sets a first positioning location 21, a second positioning location 22, a third positioning location 23, a first color data 24, a start location 25, an a waypoint position 27 and a target location 29 on the image map through an input module, such as a touch screen or a press key set. The user takes the navigation apparatus to the first positioning location 21, the second positioning location 22 and the third positioning location 23, and obtains latitude and longitude coordinates of the first positioning location 21, the second positioning location 22 and the third positioning location 23 by the satellite positioning module, and then navigation apparatus performs a positioning process for the triangular area formed by the three positioning locations 21, 22, 23.

A processing module then recognizes a plurality of workable routes according to the first color data 24 (indicating a workable route) and other color data (indicating a non-workable route) of the recreation areas, and calculates a navigation route from the start location 25 to the target location 29 through a waypoint position 27 according to a route planning algorithm, the latitude and longitude coordinates and the workable route. In the meantime, the first turning position 26 and the second turning position 28 are also calculated. Therefore, the navigation route in an order of start location 25, first turning position 26, waypoint position 27, second turning position 28 and target location 29 can be completed by the navigation apparatus, as shown in FIG. 2.

If a user finds out that any of the latitude and longitude coordinates of the first turning position 26, the second turning position 28 or one location on the navigation route is deviated, the user can use at least three positioning locations to position again for better precision. Beside, the user can set the color data of the traveled route of the navigation route as a color data indicating non-workable route to prevent the navigation apparatus from planning such traveled route in a future navigation route again or prevent the user from traveling through the traveled route repeatedly.

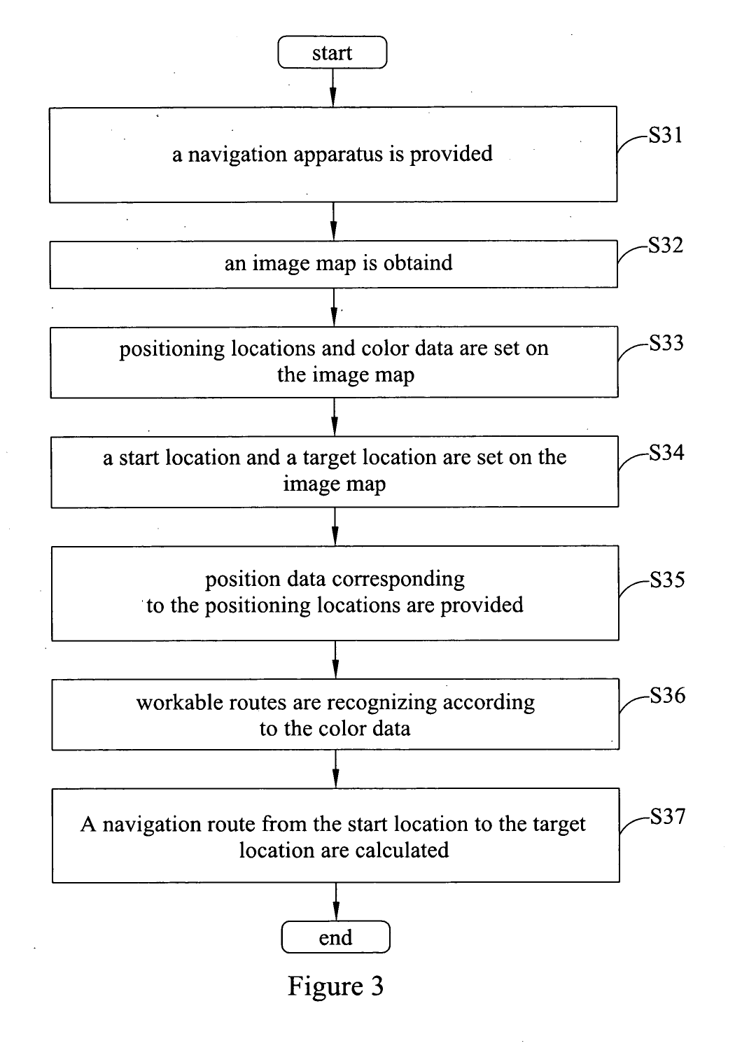

Referring to FIG. 3 for a flow chart of a navigation method using image map in accordance with the present invention, the navigation apparatus shown in FIG. 1 is used as an example to describe each step of this method, and the navigation method comprises the following steps. In step S31, a navigation apparatus 1, such as a global positioning system (GPS) device, a mobile phone with a navigation function or a digital personal assistant with a navigation function) is provided, and the navigation apparatus I comprises a storage module 11, an input module 12, a satellite positioning module 13 and a processing module 14.

In step S32, a picture of a paper map is obtained as the image map 111 which is then stored in the storage module 11 for further application. In step S33 the user sets a plurality of positioning locations 1111 and a plurality of color data 1112 on the image map 111 by using the input module 12.

In step S34 a start location 1113 and a target location 1114 are set on the image map 111. Besides, at least one waypoint position also can be set between the start location 1113 and the target location 1114.

In the step S35, the satellite positioning module 13 provides a plurality of position data 131 corresponding to the positioning locations 1111. For example, navigation apparatus 1 is taken to these positioning locations 1111 sequentially, and receives the GPS data from GPS satellites and calculates current coordinate at each positioning location 1111, and the coordinates are stored in storage module 11 and serves as position data 131.

In step S36, a plurality of workable routes 141 are recognized according to the color data 1112 by the processing module 14, and in step S37, a navigation route 142 from the start location 1113 to the target location 1114 is calculated according to a route planing algorithm 143, the position data 131 and the workable routes 141 by the processing module 14. In addition, the navigation route 142 can include a non-traveled route and a traveled route, and the non-traveled route is marked by a first color data, and the traveled route is marked by a second color data. Users can define the second color data as a non-workable route, so that the navigation apparatus 1 will not repeatedly use the traveled route tp plan route and avoid users to travel through the same workable route 141 again.

In summation of the above description, the present invention herein enhances the performance than the conventional structure and further complies with the patent application requirements and is thus duly filed for patent application. While the invention has been described by means of specific embodiments, numerous modifications and variations could be made thereto by those skilled in the art without departing from the scope and spirit of the invention set forth in the claims.

What is claimed is:

1. A navigation apparatus using image map, comprising:
a storage module for storing an image map;
an input module for setting a plurality of positioning locations, a plurality of color data, a start location and a target location on said image map;
a satellite positioning module for providing a plurality of position data corresponding to said positioning locations respectively; and
a processing module for recognizing a plurality of workable routes according to said color data, and calculating a navigation route from said start location to said target location according to a route planing algorithm, said position data and said workable routes.

2. The navigation apparatus of claim 1, wherein said navigation apparatus is a global positioning system (GPS) device, a mobile phone with a navigation function or a digital personal assistant with a navigation function.

3. The navigation apparatus of claim 1, wherein at least one waypoint position is set between said start location and said target location by said input module.

4. The navigation apparatus of claim 1, wherein said input module includes a touch screen or a press key set.

5. The navigation apparatus of claim 1, wherein said positioning locations includes at least three noncolinear positioning positions.

6. The navigation apparatus of claim 1, wherein each position data includes latitude and longitude coordinate.

7. The navigation apparatus of claim 1, wherein the navigation route further comprises a non-traveled route and a traveled route, and the non-traveled route is marked by a first color data, and the traveled route is marked by a second color data.

8. A navigation method using image map, comprising the steps of:
(a) providing a navigation apparatus which comprises a storage module, an input module, a satellite positioning module and a processing module;
(b) using said storage module to store an image map;
(c) using said input module to set a plurality of positioning locations and a plurality of color data on said image map;
(d) setting a start location and a target location on said image map;
(e) providing a plurality of position data corresponding to said positioning locations respectively by said satellite positioning module;
(f) recognizing a plurality of workable routes according to said color data by said processing module; and
(g) calculating a navigation route from said start location to said target location according to a route planing algorithm, said position data and said workable routes.

9. The navigation method of claim 8, wherein said image map is provided by using an image capturing module to a take a picture of a paper map.

10. The navigation method of claim 8, further comprising, after the step (d), a step (d1) of setting at least one waypoint position between said start location and said target location.

11. The navigation method of claim 8, wherein said input module comprises one selected from the collection of a touch screen and a press key set.

12. The navigation method of claim 8, wherein said positioning locations include at least three noncolinear positioning positions.

13. The navigation method of claim 8, wherein each position data includes latitude and longitude coordinate.

14. The navigation method of claim 8, wherein said navigation route further comprises a non-traveled route and a traveled route, and the non-traveled route is marked by a first color data, and the traveled route is marked by a second color data.
